(19) United States
(12) Patent Application Publication
(10) Pub. No.: US 2025/0333282 A1
(43) Pub. Date: Oct. 30, 2025

(54) TOOL WITH INTERCHANGEABLE HEAD

(71) Applicant: Hong Ann Tool Industries Co., Ltd., Taichung City (TW)

(72) Inventor: Cheng-Wei SU, Taichung City (TW)

(21) Appl. No.: 19/036,490

(22) Filed: Jan. 24, 2025

(30) Foreign Application Priority Data
Apr. 30, 2024 (TW) 113116180

(51) Int. Cl. B66F 15/00; B25G 3/14

(52) U.S. Cl. CPC B66F 15/00; B25G 3/14

(57) ABSTRACT

A hand tool with an interchangeable tool head comprising a lever and one or more tool heads that are removably engageable with the lever. The lever includes a slot that is configured to receive the insertion end of a tool head. The tool heads comprise hook arms that are elastically deformable. The tool heads are equipped with flanges that abut circumferential edges of the slot. The lever and tool heads are further equipped with support rods that fit into a support slot.

### BACKGROUND OF THE INVENTION

The present invention relates to hand tools, and more particularly, to a tool with an interchangeable head mechanism that enables quick and easy head replacement without the need of additional tools.

Taiwan Patent No. M647545 discloses a hand tool that comprises a connecting rod, a sleeve with a non-circular recessed portion, and a hole passing through the sleeve wall connecting to the recessed portion. A fastener engages the hole and extends into the recessed portion. The tool also comprises a pry bar assembly with multiple pry heads of different functional shapes and connecting rods. Each rod is connected to a pry head and has an insertion end with a narrower neck portion and a groove around the neck portion. The insertion end faces the recessed portion, allowing the rod to be inserted and preventing rotation relative to the sleeve. The fastener enters the groove at the neck portion, blocking the rod.

However, the tool requires external tools for head replacement, introducing unnecessary complexity. The reliance on additional tools and complicated fastening mechanisms reduces the tool's convenience and efficiency. It also suffers from cumbersome head replacement procedures, insecure locking mechanisms, and limited versatility, hindering its effectiveness for various tasks.

The present invention is, therefore, intended to obviate or at least alleviate the problems encountered in the prior art.

### SUMMARY OF THE INVENTION

The present invention provides a tool with an interchangeable head comprising a lever and a first tool head. The lever defines a slot and includes a first side and a second side opposite the first side. The first side has a first side hole communicating with the slot. The first tool head is removably engageable with the lever. The first tool head includes a first working end and a first insertion end opposite the first working end. The first insertion end includes a first hook arm integrally formed with the first working end. The first hook arm is elastically deformable. The first insertion end includes a first flange on the first hook arm. The first flange abuts a first inner circumferential edge of the first side hole when the first insertion end is inserted into the slot.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept upon which this disclosure is based may readily be utilized as a basis for designing other structures, methods, and systems for carrying out the several purposes of the invention. It is important, therefore, that the claims be regarded as including such equivalent constructions insofar as they do not deviate from the spirit and scope of the invention.

Furthermore, the purpose of the abstract is to enable the general public, particularly scientists, engineers, and practitioners in the field who may not be familiar with patent or legal terminology, to quickly determine the nature and essence of the technical information through a brief examination. The abstract is not meant to define the invention, which is determined by the claims, nor is it intended to limit the scope of the invention in any manner.

Other objectives, advantages, and new features of the invention will become apparent from the following detailed description of the invention when considered in conjunction with the accompanied drawings.

### BRIEF DESCRIPTION OF DRAWINGS

FIG. 1 is a perspective view of a tool with interchangeable head in accordance with the present invention.

FIG. 2 an exploded perspective view of the tool with interchangeable head of FIG. 1.

FIG. 3 is a cross-sectional view of the tool with interchangeable head of FIG. 1.

FIG. 4 illustrates detachment action of a first tool head of the tool with interchangeable head of FIG. 1.

FIG. 5 is an exploded perspective view of a second tool head of the tool with interchangeable head of FIG. 1.

FIG. 6 is a cross-sectional view of the second tool head of the tool with interchangeable head of FIG. 1.

### DETAILED DESCRIPTION OF THE INVENTION

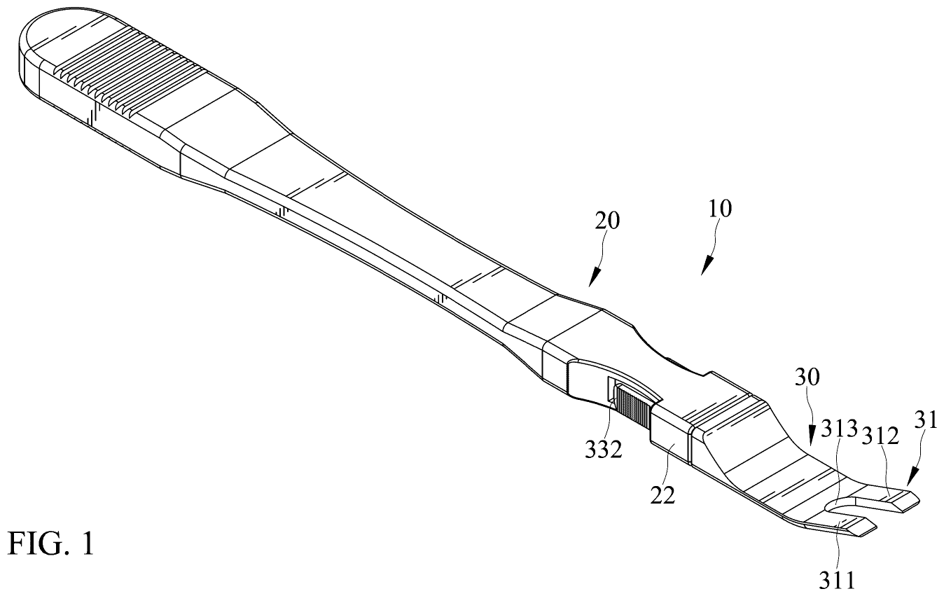

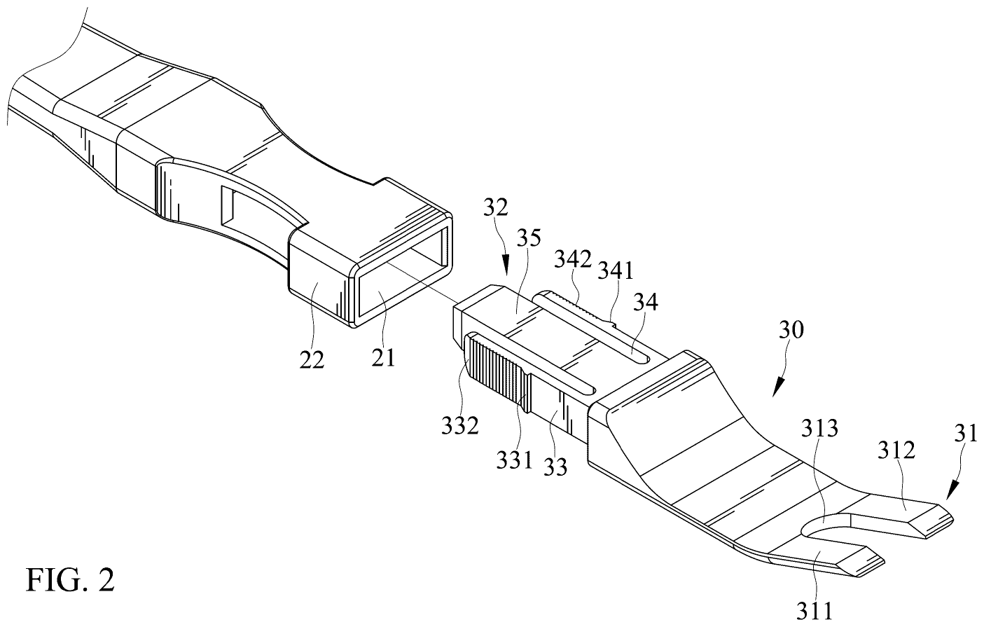

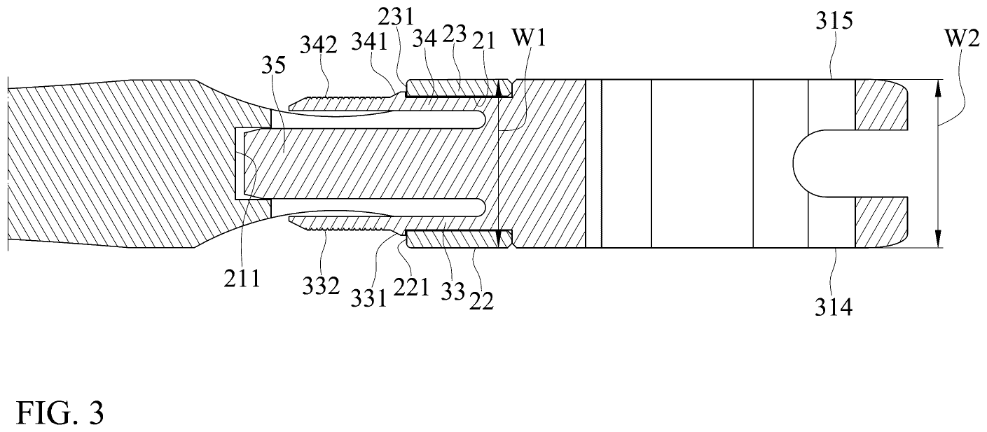

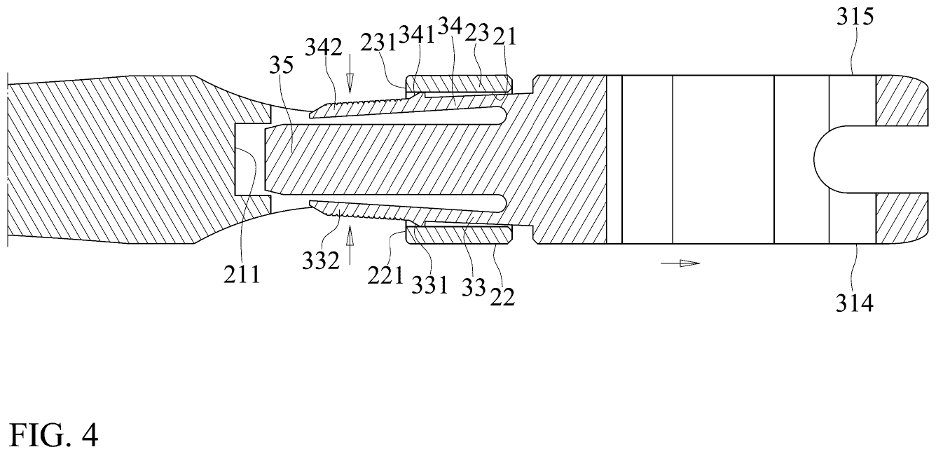

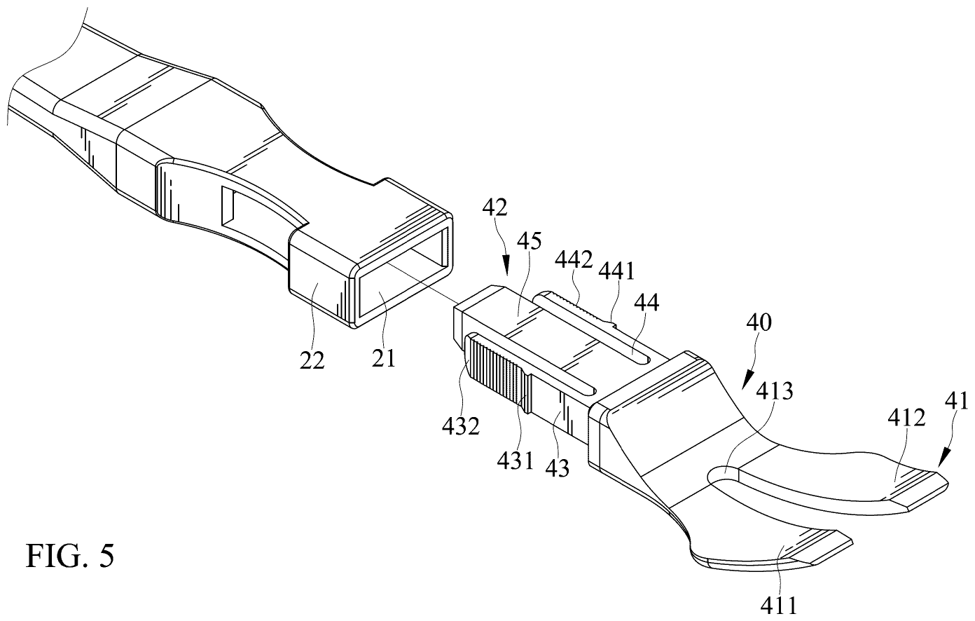

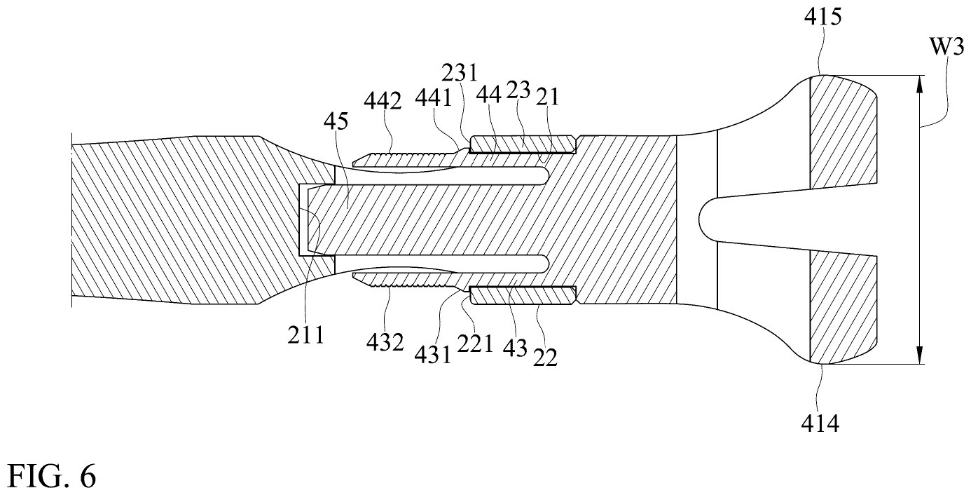

Referring to FIGS. 1-6, a tool 10 in accordance with the present invention comprises a lever 20 and either a first tool head 30 or a second tool head 40 removably engageable with the lever 20.

The lever 20 includes a slot 21 and forms a first side 22 and an opposite second side 23. The first side 22 includes a first side hole 221 communicating with the slot 21, and the second side 23 includes a second side hole 231 communicating with the slot 21.

The first tool head 30 includes a first working end 31 and a first insertion end 32 opposite to the first working end 31. The first insertion end 32 includes a first hook arm 33 and a second hook arm 34 integrally formed with the first working end 31. The first hook arm 33 and the second hook arm 34 can elastically deform to move closer to each other when pressure is applied during insertion into the slot 21 of the lever 20.

The first and second hooks arms 33 and 34 are designed to provide precise, controlled compression and expansion.

A first flange 331 extends on a side of the first hook arm 33 opposite to the second hook arm 34, and a second flange 341 extends on a side of the second hook arm 34 opposite to the first hook arm 33. The first insertion end 32 can be removably inserted into the slot 21, allowing the first flange 331 to abut against a first inner circumferential edge of the first side hole 221, and the second flange 341 to abut against a second inner circumferential edge of the second side hole 231. Upon insertion, the first and the second hook arms 33 and 34 bend inward, and the first and the second flanges 331 and 341 abut circumferential edges of the first and the second side holes 221 and 231, securing the first tool head 30 in place. When the pressure is released, the first and the second hook arms 33 and 34 return to their original position, ensuring a secure, stable connection. The clastic deformation allows for easy removal of the first tool head 30 by applying force in the opposite direction, which causes the hook arms 33 and 34 to flex outward, disengaging the first tool head 30 from the lever 20.

The second tool head 40 includes a second working end 41 and a second insertion end 42 opposite to the second working end 41. The first working end 31 and the second working part 43 can respectively be in the form of a prying head or scraper. The second insertion end 42 includes a third hook arm 43 and a fourth hook arm 44 integrally formed with the second working end 41. The third hook arm 43 and fourth hook arm 44 can elastically deform to move closer to each other.

A third flange 431 extends on a side of the third hook arm 43 opposite to the fourth hook arm 44, and a fourth flange 441 extends on the side of the fourth hook arm 44 opposite to the third hook arm 43. Either the first insertion end 32 or the second insertion end 42 can be selectively and removably inserted into the slot 21. When the second insertion end 42 is inserted into the slot 21, the third flange 431 abuts against the first inner circumferential edge of the first side hole 221, and the fourth flange 441 abuts against the second inner circumferential edge of the second side hole 231.

A first pressing part 332 extends on a side of the first hook arm 33 opposite to the second hook arm 34, a second pressing part 342 extends on a side of the second hook arm 34 opposite to the first hook arm 33, a third pressing part 432 extends on a side of the third hook arm 43 opposite to the fourth hook arm 44, and a fourth pressing part 442 extends on a side of the fourth hook arm 44 opposite to the third hook arm 43. The first, the second, the third, and the fourth pressing parts 332, 342, 432, and 442 are respectively provided with serrated surfaces. The pressing parts 332, 342, 432, and 442 enhance grip, reduce slippage, and improve the tool's ability to maintain contact with various surfaces during different operational modes.

A bottom of the slot 21 is connected to a support slot 211, with the cross sectional of the support slot 211 being smaller than a cross sectional of the slot 21. The support slot, 21 ensures precise alignment and load distribution.

The first insertion end 32 includes a first support rod 35 integrally formed with the first working end 31, positioned between the first hook arm 33 and the second hook arm 34. Similarly, the second insertion end 42 includes a second support rod 45 integrally formed with the second working end 41, positioned between the third hook arm 43 and the fourth hook arm 44. When the first insertion end 32 is inserted into the slot 21, the first support rod 35 is inserted into the support slot 211. When the second insertion end 42 is inserted into the slot 21, the second support rod 45 is inserted into the support slot 211.

The first working end 31 includes a first prying fork 311, a second prying fork 312, and a first concave groove 313 between the first prying fork 311 and the second prying fork 312. A first side edge 314 is set on a side of the first prying fork 311 opposite to the first concave groove 313, and a second side edge 315 is set on a side of the second prying fork 312 opposite to the first concave groove 313. The distance from the first side 22 to the second side 23 forms a first width W1, and the distance from the first side edge 314 to the second side edge 315 forms a second width W2, where the second width W2 is not greater than the first width W1.

The second working end 41 includes a third prying fork 411, a fourth prying fork 412, and a second concave groove 413 set between the third prying fork 411 and the fourth prying fork 412. A third side edge 414 is set on a side of the third prying fork 411 opposite to the second concave groove 413, and a fourth side edge 415 is set on a side of the fourth prying fork 412 opposite to the second concave groove 413. The distance from the third side edge 414 to the fourth side edge 415 forms a third width W3, where the third width W3 is greater than the first width W1.

In view of the foregoing, the tool 10 can provide tool head replacement functionality through the above structure. When the first tool head 30 or the second tool head 40 is connected to the lever 20, it can obtain a locking effect through the two hook arms 33, 34, 43, and 44. By pressing the two hook arms 33, 34, 43, and 44 to deform them, the first tool head 30 or the second tool head 40 can be detached from the lever 20.

Although specific embodiments have been illustrated and described, numerous modifications and variations are still possible without departing from the scope of the invention. The scope of the invention is limited by the accompanying claims.

1. A tool with interchangeable tool head comprising:
a lever, wherein the lever defines a slot and includes a first side and a second side opposite the first side, wherein the first side has a first side hole communicating with the slot;
a first tool head removably engageable with the lever, wherein the first tool head includes a first working end and a first insertion end opposite the first working end, wherein the first insertion end includes a first hook arm integrally formed with the first working end, wherein the first hook arm is elastically deformable, wherein the first insertion end includes a first flange on the first hook arm, and wherein the first flange abuts a first inner circumferential edge of the first side hole when the first insertion end is inserted into the slot.

2. The tool with interchangeable tool head as claimed in claim 1, wherein the second side has a second side hole communicating with the slot, wherein the first insertion end includes a second hook arm integrally formed with the first working end, wherein the first and the second hook arms are elastically deformable toward each other, wherein the first insertion end includes a second flange on the second hook arm, and wherein the second flange abuts a second inner circumferential edge of the second side hole when the first insertion end is inserted into the slot.

3. The tool with interchangeable tool head as claimed in claim 1, further comprising a second tool head replaceable with first tool head and removably engageable with the lever, wherein the second head includes a second working end and a second insertion end opposite the second working end, wherein the second insertion end includes a third hook arm integrally formed with the second working end, wherein the third hook arm is elastically deformable, wherein the second insertion end includes a third flange on the third hook arm, and wherein the third flange abuts the first inner circumferential edge of the first side hole when the second insertion end is inserted into the slot.

4. The tool with interchangeable tool head as claimed in claim 2, further comprising a second tool head replaceable with first tool head and removably engageable with the lever, wherein the second head includes a second working end and a second insertion end opposite the second working end, wherein the second insertion end includes a third hook arm and a fourth hook arm integrally formed with the second working end, wherein the third hook arm and the fourth hook arm are elastically deformable to move closer to each other, wherein the second insertion end includes a third flange on the third hook arm and a fourth flange on the fourth hook arm, and wherein the third and the fourth flanges respectively abut the first and the second inner circumferential edge of the first side hole when the second insertion end is inserted into the slot.

5. The tool with interchangeable tool head as claimed in claim 2, wherein the first hook arm includes a first pressing part and the second hook arm includes a second pressing part, and wherein each of the first and the second pressing parts is provided with a serrated surface.

6. The tool with interchangeable tool head as claimed in claim 4, wherein the third hook arm includes a third pressing part and the fourth hook arm includes a fourth pressing part, and wherein each of the third and the fourth pressing parts is provided with a serrated surface.

7. The tool with interchangeable tool head as claimed in claim 1, wherein a bottom of the slot is connected to a support slot, wherein the support slot has a cross sectional smaller than a cross section of the slot, wherein the first insertion end includes a first support rod integrally formed with the first working end and positioned adjacent to the first hook arm, and wherein the first support rod is inserted into the support slot when the first insertion end is inserted into the slot.

8. The tool with interchangeable tool head as claimed in claim 2, wherein a bottom of the slot is connected to a support slot, wherein the support slot has a cross sectional smaller than a cross section of the slot, wherein the first insertion end includes a first support rod integrally formed with the first working end and positioned between the third and the fourth hook arms, and wherein the first support rod is inserted into the support slot when the first insertion end is inserted into the slot.

9. The tool with interchangeable tool head as claimed in claim 3, wherein a bottom of the slot is connected to a support slot, wherein the support slot has a cross sectional smaller than a cross section of the slot, wherein the second insertion end includes a second support rod integrally formed with the second working end and positioned adjacent to the third hook arm, wherein the second support rod is inserted into the support slot when the second insertion end is inserted into the slot.

10. The tool with interchangeable tool head as claimed in claim 4, wherein a bottom of the slot is connected to a support slot, wherein the support slot has a cross sectional smaller than a cross section of the slot, wherein the second insertion end includes a second support rod integrally formed with the second working end and positioned between the third and the fourth hook arms; and wherein the second support rod is inserted into the support slot when the second insertion end is inserted into the slot.

11. The tool with interchangeable tool head as claimed in claim 1, wherein the first working end includes a first prying fork, a second prying fork and a first concave groove between the first and the second prying forks, wherein the first prying fork includes a first side edge positioned on a side of the first prying fork opposite the first concave groove, and a second side edge positioned on a side of the second prying fork opposite the first concave groove, and wherein a distance between the first side and the second side forms a first width, and a distance between the first side edge and the second side edge forms a second width not greater than the first width.

12. The tool with interchangeable tool head as claimed in claim 3, wherein the second working end includes a third prying fork, a fourth prying fork, and a second concave groove between the third and the fourth prying forks, wherein the third prying fork includes a third side edge positioned on a side of the third prying fork opposite the second concave groove, and a fourth side edge positioned on a side of the fourth prying fork opposite the second concave groove, wherein a distance between the first side and the second side forms a first width, and wherein a distance between the third side edge and the fourth side edge forms a third width greater than the first width.
